(19) United States
(12) Patent Application Publication
(10) Pub. No.: US 2020/0258137 A1
(43) Pub. Date: Aug. 13, 2020

(54) Apparatus, Method, and Non-Transitory Computer-Readable Medium for Content Recommendations

(71) Applicant: ALIBABA GROUP HOLDING LIMITED, George Town (KY)

(72) Inventors: Rui YANG, San Mateo, CA (US); Chen ZHAO, San Mateo, CA (US); Stephanie CHEN, San Mateo, CA (US); Jackson HUANG, San Mateo, CA (US)

(73) Assignee: ALIBABA GROUP HOLDING LIMITED

(21) Appl. No.: 16/271,596

(22) Filed: Feb. 8, 2019

(51) Int. Cl. G06Q 30/06

(52) U.S. Cl. CPC G06Q 30/0631; G06Q 30/0641

(57) ABSTRACT

The present disclosure provides an apparatus for content recommendations. The apparatus includes one or more storage devices that store a set of instructions, and one or more processors configured to execute the set of instructions to cause the apparatus to receive a selection of a first item via a user interface, determine, based on a first stored relationship, scent data associated with the selected first item, determine, based on a second stored relationship, theme data corresponding to the determined scent data, select a set of second items using the determined theme data, and generate content to be displayed in the user interface. The content includes the first item and the selected set of second items and is displayed in a manner associated with the determined theme data.

### BACKGROUND

Recommendation systems applied in current web-based platforms often use search engines and information retrievals to support user information inquiry when users have a clear interaction intention. For example, systems may support users to search what they want to analyze through multi-keywords queries, such as specific names, types of items, and brands, etc. But web-based platforms can have difficulty with providing appropriate recommendations when users do not have a clear interaction intention.

### SUMMARY

The present disclosure provides an apparatus for content recommendations. The apparatus includes one or more storage devices that store a set of instructions, and one or more processors. The one or more processors are configured to execute the set of instructions to cause the apparatus to receive a selection of a first item via a user interface, determine, based on a first stored relationship, scent data associated with the selected first item, determine, based on a second stored relationship, theme data corresponding to the determined scent data, select a set of second items using the determined theme data, and generate content to be displayed in the user interface. The content includes the first item and the selected set of second items and is displayed in a manner associated with the determined theme data.

The present disclosure provides a method for content recommendations. The method for content recommendations includes receiving a selection of a first item, determining, based on a first stored relationship, scent data associated with the selected first item, determining, based on a second stored relationship, theme data corresponding to the determined scent data, selecting a set of second items using the determined theme data, and generating content to be displayed in the user interface. The content includes the first item and the selected set of second items and is displayed in a manner associated with the determined theme data.

The present disclosure provides a non-transitory computer-readable medium that stores a set of instructions that is executable by one or more processors of an apparatus to cause the apparatus to perform a method for content recommendations. The method for content recommendations includes receiving a selection of a first item via a user interface, determining, based on a first stored relationship, scent data associated with the selected first item, determining, based on a second stored relationship, theme data corresponding to the determined scent data, selecting a set of second items using the determined theme data, and generating content to be displayed in the user interface. The content includes the first item and the selected set of second items and is displayed in a manner associated with the determined theme data.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating an exemplary web-based platform, consistent with embodiments of the present disclosure.

FIG. 2 is a schematic diagram illustrating an exemplary apparatus for content recommendations, consistent with embodiments of the present disclosure.

FIG. 3A illustrates an exemplary data structure of a database, consistent with embodiments of the present disclosure.

FIG. 3B illustrates an exemplary data structure of a model, consistent with embodiments of the present disclosure.

FIG. 4 is a flow diagram of an exemplary method for content recommendations, consistent with embodiments of the present disclosure

FIG. 5 is a diagram illustrating exemplary content of a webpage of an online store, consistent with embodiments of the present disclosure.

FIG. 6 is a diagram illustrating exemplary content for a product page of an online store, consistent with embodiments of the present disclosure.

FIG. 7 is a diagram illustrating an exemplary scenario of a customer browsing between the webpage of FIG. 5 and the product page of FIG. 6, consistent with embodiments of the present disclosure.

### DETAILED DESCRIPTION

The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

To solve the deficiencies of current recommendation systems as discussed above, in embodiments of the present disclosure, methods and apparatus for theme-based content recommendations are provided. When users browse content in online stores, the web-based system can display emotional storyboards, in which products with similar thematic attributes are organized in a corresponding area of storyboards.

For instance, a scent of an item could be used as thematic attributes and can be collected and classified. By collecting and classifying scent information and converting scent data into digital scent ID for smell-oriented products, a scent-emotional model can be applied to establish emotional semantic associations for products in different categories with scent-relevant products. With correlation between scent and emotion, sensation attributes of odor are used to associate various products with consistent intrinsic emotional attributes for product recommendation. Thus, an associated emotion can stimulate a customer's desire for consumption. Accordingly, an emotional-driven recommendation can be realized and introduced in the e-commerce platform.

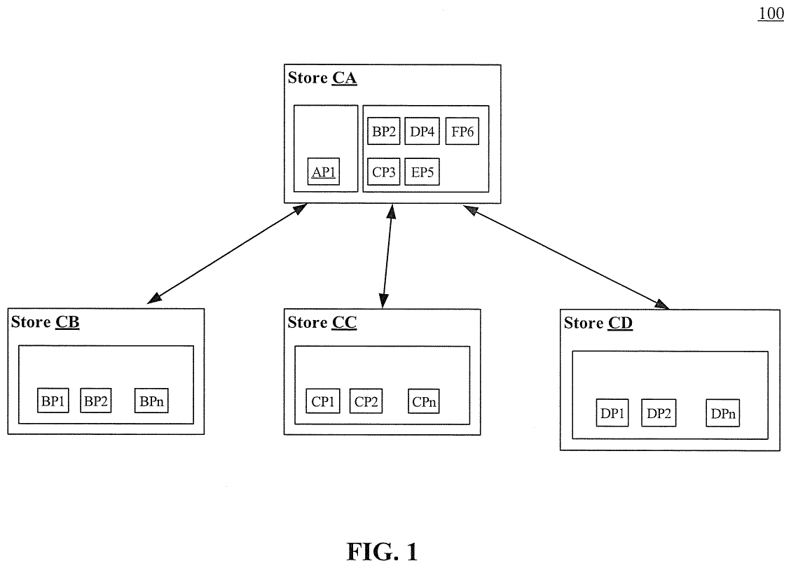

Reference is made to FIG. 1, which is a schematic diagram illustrating an exemplary web-based platform 100 consistent with embodiments of the present disclosure. Web-based platform 100 may be an online shopping platform, which includes a variety of online stores run by different users or companies. In web-based platform 100, different goods can be sold in different online stores (e.g., stores CA, CB, CC, and CD). For example, web-based platform 100 may include cloth stores selling men and women clothes, jewelry stores selling jewelries and accessories, and fragrance stores selling fragrances.

In detail, products or commodities in web-based platform 100 can be grouped into different categories, such as accessories, women clothes, women shoes, men clothes, men shoes, bags & handbags, jewelry, tea & food & supplements, watches, cameras & photo, mobile phones, computer & networking, electronics, sports goods, etc. In addition, the goods in the same major category can be further classified into different sub-categories. For example, the goods in the category for women clothes can be further divided into sub-categories such as down coats, short coats, one-piece, wedding dresses, fur, T-shirts, trousers, suits, jackets, sweaters, skirts, evening dresses, jeans, and so on.

As shown in FIG. 1, items AP1, BP1-BPn, CP1-CPn, and DP1-DPn can be products in different stores CA, CB, CC, and CD. In some embodiments, items AP1, BP1-BPn, CP1-CPn, and DP1-DPn belong to different commodity categories. For products in some commodity categories, the items are scent-relevant, while for products in some other commodity categories, the items are scent-irrelevant. The terms “scent,” and “odor” may be used interchangeably herein to refer to a characteristic smell. For example, item AP1 may be a scent-relevant item, such as foods, perfumes, air fresheners or home scents, cosmetics, bath and body products, deodorants, cleaning supplies, candles, or any other scent-oriented products. On the other hand, items BP1-BPn, CP1-CPn, and DP1-DPn may be scent-irrelevant items, such as accessories, clothes, bags, and watches.

In web-based platform 100, a content recommendations system is provided to link scent-irrelevant items BP2, CP3, DP4, EP5, and FP6 in different categories to scent-relevant item AP1 based on their thematic attributes such as “emotional attributes.” Emotional attributes as used herein may refer to characteristics of the items that arouse consumers' emotional feeling or memory to form an emotional theme in association with the items.

Emotional attributes of a scent-relevant item (e.g., item AP1) can be associated with a scent pattern of the item. That is, a particular scent or smell can link a “theme”, such as a particular scene, an emotional feeling, a memory or an imagery to a consumer, and influence behaviors of the consumer.

On the other hand, for scent-irrelevant items, the emotional attributes can be associated with other characteristics, such as colors, shapes, designs, fabrics, functions, etc. For example, flower patterns, floral backgrounds, pink colors, or smooth fabrics may link to a “romantic” emotional theme. Bright yellow colors or sportswear fabric may link to an “energetic” emotional theme.

These emotional attributes of scent-relevant or scent-irrelevant items may be culture-dependent or culture-independent. For example, a red color may link to a wedding scenario in Chinese culture, while a white color may link to the wedding scenario in traditional western culture. Different cultures may have their own interpretations and emotional reactions to the same color, scent, or items.

Web-based platform 100 can generate contents to be displayed on a user interface (e.g., a shopping page on a website or in a mobile application), to recommend goods in different categories with consistent themes or emotional attributes. Thus, the scent information of the scent-relevant item AP1 can be used as an emotional carrier to arouse favorable emotions, feelings, memories, even dreams of the consumers and to provoke their deep desire to consumption. Thus, web-based platform 100 can apply the recommendation system, in an emotion-driven approach, to bring a satisfying online shopping experience and to boost consumptions.

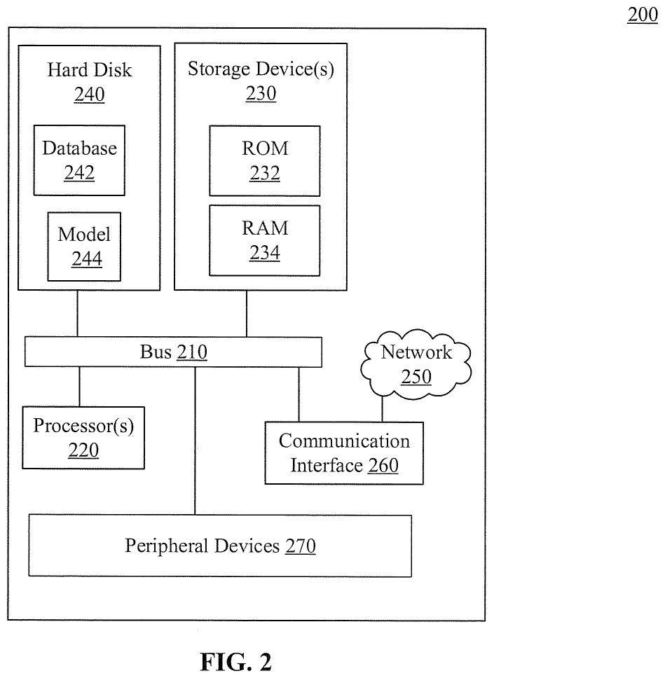

Reference is made to FIG. 2, which is a schematic diagram illustrating an exemplary apparatus 200 for content recommendations consistent with embodiments of the present disclosure. In some embodiments, apparatus 200 may be a server to implement the recommendation system as discussed above in FIG. 1 but is not limited thereto. According to FIG. 2, apparatus 200 includes a bus 210 or other communication mechanism for communicating information, and one or more hardware processor(s) 220 communicatively coupled with bus 210 for processing information. Hardware processor(s) 220 can be, for example, one or more central processors or microprocessors. Bus 210 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Apparatus 200 further includes one or more storage device(s) 230. Storage device(s) 230 can be various computer-readable media implemented in any method or technology for storage of information such as computer-readable instructions, data structures, program modules or other data. Storage device(s) 230 can be communicatively coupled with processor(s) 220 via bus 110. In some embodiments, storage device(s) 230 may include a main memory, which can be used for storing temporary variables or other intermediate information during execution of instructions by processor(s) 220. Such instructions, after being stored in non-transitory storage media accessible to processor(s) 220, render apparatus 200 into a special-purpose machine that is customized to perform operations specified in the instructions. The term “non-transitory media” as used herein refers to any non-transitory media storing data or instructions that cause a machine to operate in a specific fashion. Such non-transitory media can include non-volatile media and/or volatile media. Non-transitory media include, for example, optical or magnetic disks, dynamic memory, a floppy disk, a flexible disk, hard disk, solid state drive, magnetic cassettes, magnetic tape, or any other magnetic data storage medium, a CD-ROM, digital versatile disks (DVD) or any other optical data storage medium, any physical medium with patterns of holes, a Random Access Memory (RAM), a read-only memory (ROM), a Programmable Read-Only Memory (PROM), a EPROM, a FLASH-EPROM, NVRAM, flash memory, or other memory technology and/or any other storage medium with the same functionality that can be contemplated by persons of ordinary skill in the art to which this disclosure pertains.

In the embodiments consistent with apparatus 200 shown in FIG. 2, storage device(s) 230 may include a memory, which includes computer-readable media in the form of volatile or nonvolatile memory such as read only memory (ROM) 232 and random-access memory (RAM) 234. A basic input/output system (BIOS) containing the basic routines that help to transfer information between elements within apparatus 200 is typically stored in ROM 234. Additionally, RAM 232 may contain operating system (OS), applications, other programmable code, and programs. The RAM 232 typically contains data or program modules that are immediately accessible to or presently being operated on by the processor(s) 220.

In some embodiments, apparatus 200 may also include other removable/non-removable, volatile/nonvolatile computer media. By way of example, FIG. 2 illustrates a hard disk 240 that reads from or writes to non-removable, nonvolatile magnetic media. In some other embodiments, apparatus 200 may also include a memory device that may be an optical disk drive or a magnetic disk drive that reads from or writes to a removable, a nonvolatile storage medium such as an optical disk or magnetic disk. Other removable/non-removable, volatile/nonvolatile computer storage media that can be used in exemplary apparatus 200 include, but are not limited to, magnetic tape cassettes, flash memory cards, digital versatile disks, digital video tape, solid state RAM, and solid state ROM. The hard disk 240 and the storage device(s) 230 may be connected to bus 210 through a storage path.

Hard disk 240 or storage device(s) 230 may further store a database 242, which includes scent data and theme data in association with the items in web-based platform 100. Further, hard disk 240 or storage device(s) 230 may further store a scent-emotional model 244, which includes an association between the scent data and the theme data. In some embodiments, database 242 and scent-emotional model 244 may be stored in an external storage device in communication with apparatus 200 via network 250 or may be accessed via any other suitable network. For example, data required by apparatus 200, including database 242 and scent-emotional model 244, can also be stored in a cloud server for large-scale usage.

Apparatus 200 can transmit data to and communicate with other servers and receive responses from client terminals through network 250. Network 250 may be a local network, an internet service provider, internet, or any combination thereof. A communication interface 260 of apparatus 200 is connected to network 250. In addition, apparatus 200 can be coupled via bus 210 to one or more peripheral devices 270, which includes displays (e.g., cathode ray tube (CRT), liquid crystal display (LCD), touch screen, etc.), input devices (e.g., keyboard, mouse, soft keypad, etc.), or other output devices (e.g., speaker, headphone, etc.).

In some other embodiments, apparatus 200 can also be implemented using customized hard-wired logic, one or more ASICs or FPGAs, firmware, or program logic that in combination with the server causes apparatus 200 to be a special-purpose machine.

Apparatus 200 may include or may access one or more storage device(s) 230 configured to store data and/or software instructions used by processor(s) 220 to perform operations consistent with the disclosed embodiments. For example, processor(s) 220 can be configured to execute a set of instructions stored in the storage device(s) 230 to cause apparatus 200 to perform a method for recommending items applied in web-based platform 100, in order to display goods with consistent themes or emotional attributes on a user interface to promote consumptions as mentioned above.

Various forms of media can be involved in storing one or more sequences of one or more instructions for processor(s) 220 to execute. For example, the instructions can initially be stored on a magnetic disk or solid-state drive of a remote computer. The remote computer can load the instructions into its dynamic memory and send the instructions over a telephone line using a modem. A modem local to apparatus 200 can receive the data on the telephone line and use an infra-red transmitter to convert the data to an infra-red signal. An infra-red detector can receive the data carried in the infra-red signal and appropriate circuitry can place the data on bus 110. Bus 210 carries the data to the main memory within storage device(s) 230, from which processor(s) 220 retrieves and executes the instructions.

The disclosed embodiments are not limited to separate programs or computers configured to perform dedicated tasks. For example, storage device(s) 230 may store a single program or multiple programs. Additionally, apparatus 200 may execute one or more programs located remotely. For example, apparatus 200 may access one or more remote programs stored in a remote component (such as a database) that, when executed, perform operations consistent with the disclosed embodiments. In addition, other components known to one of ordinary skill in the art may be included in apparatus 200 to process, transmit, provide, and receive information consistent with the disclosed embodiments.

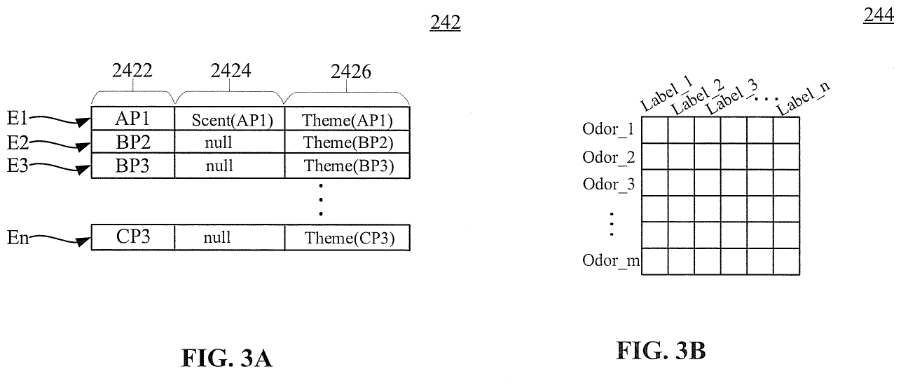

For further understanding of database 242, reference is made to FIG. 3A, which illustrates an exemplary data structure of database 242 consistent with embodiments of the present disclosure. As shown in FIG. 3A, entries E1-En in database 242 include an item ID field 2422 for indexing, a scent data field 2424, and a theme data field 2426. In some embodiments, additional fields may be introduced in the entries to store further product information, such as product title, merchant or company information, prices, stock quantities, stock location, descriptive tags, etc.

In some embodiments, scent patterns of scent-relevant items can be analyzed and collected using a gas detecting device configured to detect odors or flavors of the items. For example, an electronic nose may include one or more sensors, including metal-oxide-semiconductor (MOSFET) devices, conducting polymers, quartz crystal microbalance (QCM), or surface acoustic wave (SAW) devices to detect volatile molecules of the sample. When in contact with volatile compounds, the sensors react, and cause a physical change (e.g. a change of electrical properties). Thus, the electronic nose is able to identify and capture odor information, which is recorded and transformed into digital values. The digital values can be further computed and analyzed based on various statistical models, in order to obtain the scent data, e.g., scent data Scent(AP1), associated with the scent-relevant item, e.g., item AP1. Accordingly, database 242 can store a first relationship including the scent-relevant items and their scent data.

For example, in some embodiments, apparatus 200 may apply vector analysis to the scent data to evaluate the similarities of the scent data associated with different items. It is noted that a variety of algorithmic techniques can be applied for scent classification in the database. For example, in some other embodiments, a multivariate analysis can also be used to identify the relationship between different digitalized scent information. Further, machine learning technology can also be adopted to identify increasing number and variety of scent information and to classify massive scent data based on various big data analysis tools.

In some embodiments, apparatus 200 can establish an association between the scent data and the theme data, and can store a second relationship including the association in the one or more storage devices of the apparatus. More particularly, apparatus 200 can apply a scent-emotional model (e.g., model 244 in FIG. 2) to identify emotions or themes related to the scent. Thus, theme data, e.g., Theme(AP1), associated with a scent-relevant item, e.g., item AP1, can be determined using the scent-emotional model. More particularly, the theme data referred to herein may contain one or more theme labels associated with the corresponding scent data. The association may be semantic associations, which refer to preference of items, such as different odor characteristics, in a certain semantic relation to the other items, such as different theme labels expressing feelings.

For further understanding of model 244, reference is made to FIG. 3B, which illustrates an exemplary data structure of model 244 consistent with embodiments of the present disclosure. As shown in FIG. 3B, model 244 can include a matrix having m rows, representing different odor components Odor_1-Odor_m, and n columns, representing different theme labels Label_1-Label_n, in which m and n can be any integer. In some embodiments, theme labels may also be referred as emotional labels represent specific types of feelings.

Elements of the matrix can be used to indicate how theme labels Label_1-Label_n are associated with odor components Odor_1-Odor_m. For example, if odor component Odor_x is associated with theme label Label_y, a true value, e.g., “1,” may be assigned to element (x, y) in the matrix. On the other hand, if odor component Odor_x is not associated with theme label Label_y, a false value, e.g., “0,” may be assigned to element (x, y) in the matrix. In some embodiments, values of the elements can also be used to indicate the different association levels or intensities. For example, a greater value may be used to indicate a stronger link between the odor component and the theme label, while a smaller value indicates a weaker linking between the odor component and the theme label.

Various Emotion and Odor Scales (EOS) are developed to measure affective feelings associated with odor perception. For example, a Universal Emotion and Odor Scale (UniGEOS) encompasses 25 emotional terms, which are grouped into nine emotional categories including unpleasant feelings, happiness/delights, sensuality/desire, energy, soothing/peacefulness, hunger/thirst, interest, nostalgia, and spirituality. It is noted that different scales may encompass different numbers of emotional terms and group the emotional terms in different numbers of emotional categories.

These Emotion and Odor Scale can be applied as the scent-emotional model to link one or more theme labels with the scent data of a selected item to obtain the theme data corresponding to the selected item and store the theme data in the corresponding entry. Further, while existed scent-emotional scale and sensory evaluation methods can be applied to build theme label for various scent-relevant and scent-irrelevant products, machine learning technology may also be applied to improve the accuracy and efficiency of identifying theme labels for items in a large scale.

Returning to FIG. 3A, in database 242, the associated theme labels may be stored in a numeric form (e.g., a label ID number), or in a string form (e.g., a term expressing the emotional feeling) in theme data field 2426. Further, in some embodiments, the theme data includes one or more theme labels and one or more weights of the theme labels. For example, an exemplary theme data of a fragrance product may indicate 30% romantic, 20% amusement, and 50% energetic. Accordingly, based on the scent-emotional model, the associated emotional attributes for the scent-relevant items can be obtained and stored in database 242.

On the other hand, scent data field 2424 of an entry of the scent-irrelevant item may be null in the data structure shown in FIG. 3A, and theme data, e.g., Theme(BP2), Theme(BP3), Theme(CP2) associated with scent-irrelevant items, e.g., items BP2, BP3, and CP3, can be determined by an expert sensory evaluation method, but the present disclosure is not limited there to. In the expert sensory evaluation method, theme data of scent-irrelevant items may be determined and recorded based on responses of sensory specialist evaluators to the tested items.

Similarly, machine learning technology may be applied in this process of determining theme data associated with a scent-irrelevant item.

It is noted that data structures shown in FIG. 3A and FIG. 3B are merely an example and not meant to limit the present disclosure. In some other embodiments, database 242 may contain one sub-database to store scent data and theme data of the scent-relevant items, and another sub-database to store theme data of the scent-irrelevant items. Model 244 can also be implemented by various approaches.

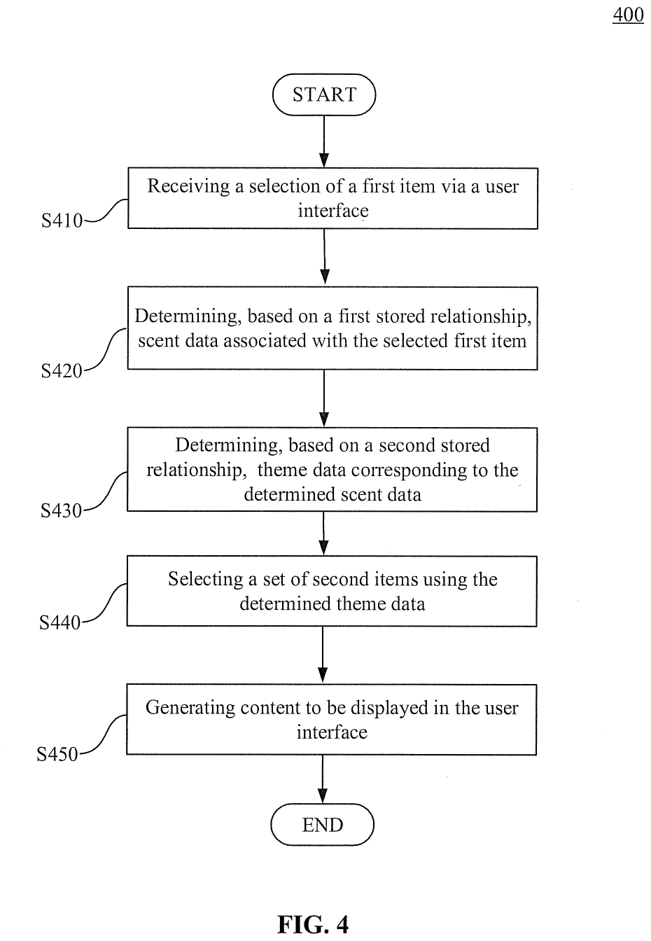

Reference is made to FIG. 4, which is a flow diagram of an exemplary method 400 for content recommendations, consistent with embodiments of the present disclosure. Method 400 can be performed by an apparatus for content recommendations (e.g., apparatus 200 in FIG. 2), but the present disclosure is not limited thereto.

In step S410, the apparatus receives a selection of a first item via a user interface. In some embodiments, the first item can be selected from multiple scent-relevant items. For example, when browsing in a fragrance online store (e.g., store CA in FIG. 1), a customer may, by clicking on or hovering over corresponding product text or images, select one of the fragrance products (e.g., scent-relevant item AP1 in FIG. 1) in the store. Accordingly, at a server side, the apparatus can receive the selection through corresponding data transmitted via the network.

In step S420, the apparatus determines, based on a first stored relationship, scent data associated with the selected first item. In some embodiments, apparatus can determine the scent data by accessing a database (e.g., database 242 in FIG. 2 and FIG. 3A) storing the first stored relationship and retrieving corresponding information from the database.

After the scent data is determined, in step S430, the apparatus determines, based on a second stored relationship, theme data corresponding to the determined scent data. In some embodiments, the theme data includes one or more associated theme labels. Responsive to the scent data of the selected first item, the apparatus determines, from multiple theme labels, one or more associated theme labels corresponding to the selected first item based on the association (e.g., model 244 in FIG. 3B).

Further, the apparatus can also determine one or more weights of the one or more associated theme labels based on the association, responsive to the scent data of the selected first item. Thus, the apparatus can store the one or more weights in the theme data together with the one or more associated theme labels.

Similarly, the theme data can also be stored in a corresponding field (e.g., theme data field 2426 in FIG. 3A) in the entry associated with the selected item in the database (e.g., database 242 in FIG. 2 and FIG. 3A). Thus, apparatus 200 can determine the theme data by accessing the database and retrieving corresponding information from the database.

In step S440, the apparatus selects a set of second items (e.g., scent-irrelevant items BP2, CP3, DP4, EP5, and FP6 in FIG. 1) using the determined theme data. In some embodiments, the apparatus can perform a search in the database, and select the items with the theme data consistent with selected first item. For example, the apparatus can select one candidate item in the set of second items, if the theme data of the selected candidate item has one or more identical theme labels. In another example, the apparatus can evaluate a similarity between the theme data of one candidate item and the determined theme data of the selected first item. If the similarity is greater than a threshold value, the apparatus can select the candidate item in the set of second item. Various methods can be applied to define whether the theme data is consistent, and thus the examples discussed above are not meant to limit the present disclosure.

After the set of second items is selected, in step S450, the apparatus can generate content to be displayed in a user interface. The content includes the first item and the selected set of second items and is displayed in a manner associated with the determined theme data. In some embodiments, the content includes a scent-relevant item sub-region for displaying the selected first item, and a scent-irrelevant item sub-region for displaying the selected set of second items.

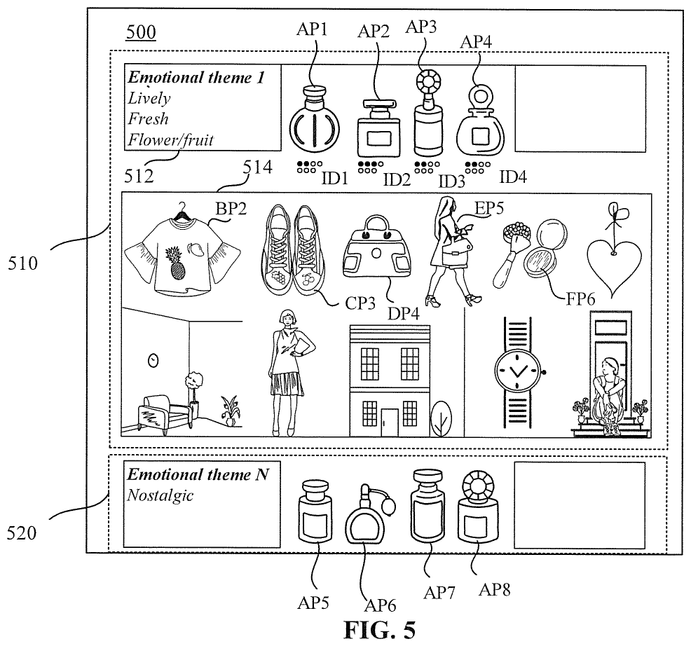

For further understanding, reference is made to FIG. 5, which is a diagram illustrating exemplary content of a webpage 500 of an online store CA selling scent-relevant items consistent with embodiments of the present disclosure. For example, online store CA may be a perfume company, and content of webpage 500 in online store CA displays the scent products based on emotional themes of smells.

One or more recommendation boards 510, 520 are applied to webpage 500. Emotional recommendation board 510 links to a theme and includes a description 512 of the theme, a scent-relevant item sub-region and a scent-irrelevant item sub-region. The scent-relevant item sub-region includes one or more scent-relevant items AP1-AP4 associated with the theme. The scent-irrelevant item sub-region includes a storyboard 514, which visualizes the theme corresponding to the scent of items AP1-AP4 in a story way to communicate the corresponding emotional theme.

Content description 512 of the theme can be determined based on the associated theme label(s) of the theme. For example, the theme of recommendation board 510 may be “Lively,” “Fresh,” and “Flower/Fruit.” The storyboard 514 shows items (e.g., items BP2, CP3, DP4, EP5, and FP6) that are consistent with the theme, e. g., sharing the same or similar theme, such as similar spiritual or emotional attributes associated with the scent of items AP1-AP4. For example, the items displayed in storyboard 514 may include associated sceneries, fashion goods, foods, furniture, and household items, etc.

In some embodiments, the background color, fonts, or other designs in recommendation board 510 can be consistent to characteristics or description of the theme. For example, for the theme of “Lively,” “Fresh,” and “Flower/Fruit” in recommendation board 510, a pink color may be chosen as the background imaging. On the other hand, for the theme of “Nostalgic” associated with items AP5-AP8 in another recommendation board 520, a green color may be chosen as the background imaging. Similarly, a theme of “Aggressive” may be represented by a dark red color, a theme of “Pure” may be represented by a white color, a theme of “Refreshing” may be represented by a light blue color, and so on. In some embodiments, these manners of displaying can be adjusted based on different interpretations in different cultures. Accordingly, storyboard 514 visually organizes products from different stores and combines different types of items with emotional consistency in the form of “stories,” to achieve product recommendation in the storyboard 514.

Further, in some embodiments, emotional recommendation board 510 can also display the associated scent-relevant items AP1-AP4 with visual codes ID1-ID4 in the scent-relevant item sub-region. Visual codes ID1-ID4 are used to identify scent patterns of scent-relevant items AP1-AP4. More particularly, the apparatus is configured to identify scent-relevant items AP1-AP4 to be displayed in the content, and to generate one or more visual codes based on the scent data of the identified scent-relevant items AP1-AP4. Thus, the apparatus can display scent-relevant items AP1-AP4 in a manner associated with the corresponding visual codes.

For example, visual codes ID1-ID4 can indicate the types of the odor by different hue of the color and indicate the scent concentration by value or chroma of the color. Accordingly, customers can have a further understanding of scent characteristics of scent-relevant items AP1-AP4 when viewing webpage 500 in web-based platform 100.

Thus, when a customer enters online store CA and selects one product to view details of the product, webpage 500 of online store CA displays visual codes ID1-ID4 and storyboard 514 using scent as a clue. Scent-relevant items AP1-AP4 and scent-irrelevant items BP2, CP3, DP4, EP5, and FP6 with similar emotional attribute are connected to the same theme, which stimulates desire of customers to buy the products reflecting their pursuits, emotions, and memories.

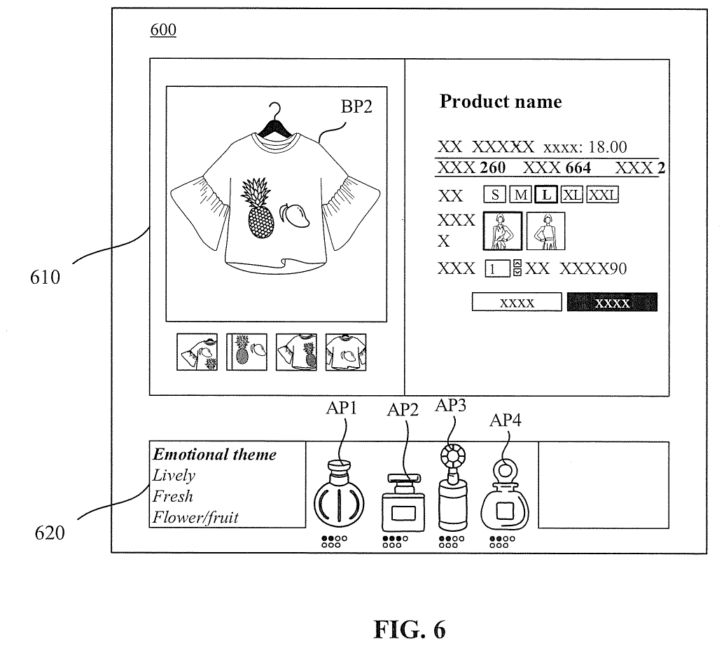

For further understanding, reference is made to FIG. 6, which is a diagram illustrating exemplary content for a product page 600 of an online store consistent with embodiments of the present disclosure. As shown in FIG. 6, the content to be displayed in product page 600 includes a product region 610 and a recommendation region 620. The product information, such as a product name, photos, price, sizes, etc., can be displayed in the product region 610. Recommendation region 620 also appears in product page 600 and displays scent-relevant items AP-AP4. That is, recommendation region 620 may contain synchronized recommendation of the scent product of online store CA, or other scent-relevant or scent-irrelevant products of other online stores. By this way, products that belong to the same theme can be linked with each other.

More particularly, similar to method 400 in FIG. 4, in some embodiments, apparatus 200 can receive a selection of a scent-irrelevant item, such as item BP2, determine the theme data corresponding to the selected scent-irrelevant item, select a set of scent-relevant items (such as items AP1-AP4) using the determined theme data, and generate the content to be displayed in the user interface. Similarly, content in product page 600 includes scent-irrelevant item BP2 and the selected set of scent-relevant items AP1-AP4 and is displayed in the manner associated with the determined theme data.

It is noted that in various embodiments, product region 610 can also contain a scent-relevant item, and corresponding recommendation region 620 may contain a set of scent-irrelevant items that are associated with the scent-relevant item. Alternatively stated, product page 600 can be a product page in online store CB selling scent-irrelevant products, and can also be a product page in online store CA selling scent-relevant products.

Apparatus 200 can first identify an item displayed in product region 610. Responsive to the displayed item being a scent-relevant item, apparatus 200 selects a set of scent-irrelevant items using the theme data associated with the item displayed in product region 610 and displays the selected set of scent-irrelevant items in recommendation region 620. On the other hand, responsive to the displayed item being a scent-irrelevant item, apparatus 200 selects a set of scent-relevant items using the theme data associated with the item displayed in product region 610 and displays the selected set of scent-relevant items in the recommendation region 620.

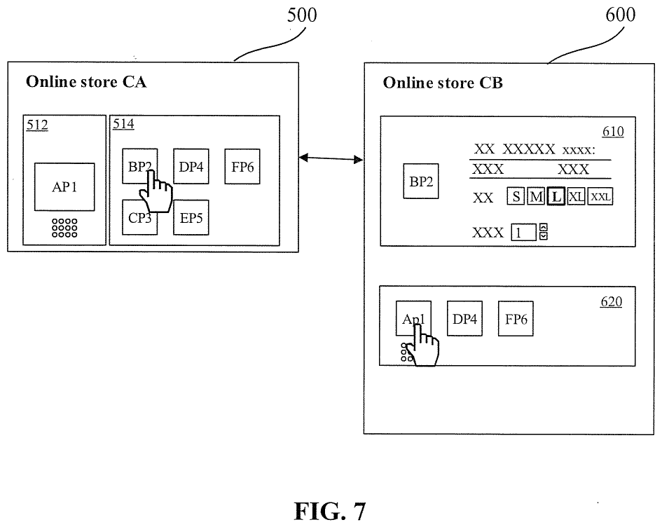

FIG. 7 is a diagram illustrating an exemplary scenario of a customer browsing between webpage 500 of online store CA and product page 600 of another online store CB consistent with embodiments of the present disclosure. As shown in FIG. 7, when a customer finds an item (e.g., item BP2) that he or she is interested in from storyboard 514 of webpage 500 of online store CA, he or she can click the item (e.g., item BP2) and then enter product page 600 of item BP2 in online store CB.

Accordingly, the customer can check details of item BP2 in product page 600. In addition, in product page 600, one or more scent-relevant items (e.g., item AP1) or one or more scent-irrelevant items (e.g., item DP4, FP6) associated with the same theme are displayed and recommended in recommendation region 620 of product page 600. Similarly, the customer can click on item AP1, and then enter webpage 500 of online store CA, or can click on other items, such as item DP4 or item FP6, and then enter corresponding product pages of different online stores.

In view of above, methods and apparatus for emotion-driven content recommendations are provided in various embodiments of the present disclosure, which can be integrated in various web-based platforms. Accordingly, by arousing or inspiring favorable emotions of consumers to a corresponding theme, web-based platforms can encourage consumptions and improve user's online shopping experience.

The various example embodiments described herein are described in the general context of method steps or processes, which may be implemented in one aspect by a computer program product, embodied in a transitory or a non-transitory computer-readable medium, including computer-executable instructions, such as program code, executed by computers in networked environments. A computer-readable medium may include removeable and nonremovable storage devices including, but not limited to, Read Only Memory (ROM), Random Access Memory (RAM), compact discs (CDs), digital versatile discs (DVD), etc.

Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as exemplary only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

1. An apparatus for content recommendations, comprising:
one or more storage devices that store a set of instructions; and
one or more processors configured to execute the set of instructions to cause the apparatus to:
receive a selection of a first item via a user interface,
determine, based on a first stored relationship, scent data associated with the selected first item,
determine, based on a second stored relationship, theme data corresponding to the determined scent data,
select a set of second items using the determined theme data, and
generate content to be displayed in the user interface, wherein the content includes the first item and the selected set of second items and is displayed in a manner associated with the determined theme data.

2. The apparatus for content recommendations of claim 1, wherein the first item is selected from a plurality of scent-relevant items, the one or more storage devices further store a database storing the first relationship including the plurality of scent-relevant items and the scent data of the plurality of scent-relevant items, and the one or more processors are further configured to execute the set of instructions to cause the apparatus to determine the scent data associated with the selected first item by accessing the database.

3. The apparatus for content recommendations of claim 1, wherein the one or more processors are further configured to execute the set of instructions to cause the apparatus to:
establish an association between the scent data and the theme data, wherein the second relationship including the association is stored in the one or more storage devices.

4. The apparatus for content recommendations of claim 1, wherein the theme data comprises one or more associated theme labels selected from a plurality of theme labels, and the one or more processors are further configured to execute the set of instructions to cause the apparatus to determine the theme data corresponding to the determined scent data by:
responsive to the scent data of the selected first item, determining, from the plurality of theme labels, the one or more associated theme labels corresponding to the selected first item based on the association.

5. The apparatus for content recommendations of claim 4, wherein the theme data further comprises one or more weights of the one or more associated theme labels, and the one or more processors are further configured to execute the set of instructions to cause the apparatus to determine the theme data corresponding to the determined scent data by:
responsive to the scent data of the selected first item, determining the one or more weights of the one or more associated theme labels based on the association.

6. The apparatus for content recommendations of claim 1, wherein the one or more processors are further configured to execute the set of instructions to cause the apparatus to:
receive a selection of a scent-irrelevant item,
determine the theme data corresponding to the selected scent-irrelevant item,
select a set of scent-relevant items using the determined theme data, and
generate the content to be displayed in the user interface, wherein the content includes the scent-irrelevant item and the selected set of scent-relevant items and is displayed in the manner associated with the determined theme data.

7. The apparatus for content recommendations of claim 1, wherein the content to be displayed includes a product region and a recommendation region, and the one or more processors are further configured to execute the set of instructions to cause the apparatus to generate the content to be displayed by:
identifying an item displayed in the product region;
responsive to the displayed item being a scent-relevant item, selecting a set of scent-irrelevant items using the theme data associated with the displayed item;
displaying the selected set of scent-irrelevant items in the recommendation region;
responsive to the displayed item being a scent-irrelevant item, selecting a set of scent-relevant items using the theme data associated with the displayed item; and
displaying the selected set of scent-relevant items in the recommendation region.

8. A method for content recommendations, comprising:
receiving a selection of a first item via a user interface;
determining, based on a first stored relationship, scent data associated with the selected first item;
determining, based on a second stored relationship, theme data corresponding to the determined scent data;
selecting a set of second items using the determined theme data; and
generating content to be displayed in the user interface, wherein the content includes the first item and the selected set of second items and is displayed in a manner associated with the determined theme data.

9. The method for content recommendations of claim 8, further comprising:
storing the first relationship including a plurality of scent-relevant items and the scent data of the plurality of scent-relevant items in a database, wherein the first item is selected from the plurality of scent-relevant items; and
accessing the database to determine the scent data associated with the selected first item.

10. The method for content recommendations of claim 8, further comprising:
establishing an association between the scent data and the theme data; and
storing the second relationship including the association in one or more storage devices.

11. The method for content recommendations of claim 8, wherein the theme data comprises one or more associated theme labels, and determining the theme data corresponding to the determined scent data comprises:
responsive to the scent data of the selected first item, determining, from a plurality of theme labels, the one or more associated theme labels corresponding to the selected first item based on the association.

12. The method for content recommendations of claim 11, wherein the theme data further comprises one or more weights of the one or more associated theme labels, and determining the theme data corresponding to the determined scent data further comprises:
responsive to the scent data of the selected first item, determining the one or more weights of the one or more associated theme labels based on the association.

13. The method for content recommendations of claim 8, further comprises:
receiving a selection of a scent-irrelevant item;
determining the theme data corresponding to the selected scent-irrelevant item;
selecting a set of scent-relevant items using the determined theme data; and
generating the content to be displayed in the user interface, wherein the content includes the scent-irrelevant item and the selected set of scent-relevant items and is displayed in the manner associated with the determined theme data.

14. The method for content recommendations of claim 8, wherein generating the content to be displayed further comprises:
identifying an item displayed in a product region of the content;
responsive to the displayed item being a scent-relevant item, selecting a set of scent-irrelevant items using the theme data associated with the displayed item; and
displaying the selected set of scent-irrelevant items in a recommendation region of the content;
responsive to the displayed item being a scent-irrelevant item, selecting a set of scent-relevant items using the theme data associated with the displayed item; and
displaying the selected set of scent-relevant items in the recommendation region.

15. A non-transitory computer-readable medium that stores a set of instructions that is executable by one or more processors of an apparatus to cause the apparatus to perform a method for content recommendations, the method for content recommendations comprising:
receiving a selection of a first item via a user interface;
determining scent data, based on a first stored relationship, associated with the selected first item;
determining theme data, based on a second stored relationship, corresponding to the determined scent data;
selecting a set of second items using the determined theme data; and
generating content to be displayed in a user interface, wherein the content includes the first item and the selected set of second items and is displayed in a manner associated with the determined theme data.

16. The non-transitory computer-readable medium of claim 15, wherein the set of instructions that is executable by the one or more processors of the apparatus to cause the apparatus to further perform:
storing the first relationship including a plurality of scent-relevant items and the scent data of the plurality of scent-relevant items in a database, wherein the first item is selected from the plurality of scent-relevant items; and
accessing the database to determine the scent data associated with the selected first item.

17. The non-transitory computer-readable medium of claim 15, wherein the set of instructions that is executable by the one or more processors of the apparatus to cause the apparatus to further perform:
establishing an association between the scent data and the theme data; and
storing the second relationship including the association in one or more storage devices.

18. The non-transitory computer-readable medium of claim 15, wherein the theme data comprises one or more associated theme labels, and the set of instructions that is executable by the one or more processors of the apparatus to cause the apparatus to determine the theme data corresponding to the determined scent data by:
responsive to the scent data of the selected first item, determining, from a plurality of theme labels, the one or more associated theme labels corresponding to the selected first item based on the association.

19. The non-transitory computer-readable medium of claim 18, wherein the theme data further comprises one or more weights of the one or more associated theme labels, and the set of instructions that is executable by the one or more processors of the apparatus to cause the apparatus to determine the theme data corresponding to the determined scent data by:
responsive to the scent data of the selected first item, determining the one or more weights of the one or more associated theme labels based on the association.

20. The non-transitory computer-readable medium of claim 15, wherein the set of instructions that is executable by the one or more processors of the apparatus to cause the apparatus to further perform:
receiving a selection of a scent-irrelevant item;
determining the theme data corresponding to the selected scent-irrelevant item;
selecting a set of scent-relevant items using the determined theme data; and
generating the content to be displayed in the user interface, wherein the content includes the scent-irrelevant item and the selected set of scent-relevant items and is displayed in the manner associated with the determined theme data.

21. The non-transitory computer-readable medium of claim 15, wherein the set of instructions that is executable by the one or more processors of the apparatus to cause the apparatus to generate the content to be displayed by:
identifying an item displayed in a product region of the content;
responsive to the displayed item being a scent-relevant item, selecting a set of scent-irrelevant items using the theme data associated with the displayed item;
displaying the selected set of scent-irrelevant items in a recommendation region of the content;
responsive to the displayed item being a scent-irrelevant item, selecting a set of scent-relevant items using the theme data associated with the displayed item; and
displaying the selected set of scent-relevant items in the recommendation region.
